(19) United States
(12) Patent Application Publication
(10) Pub. No.: US 2019/0002098 A1
(43) Pub. Date: Jan. 3, 2019

(54) Aircraft

(71) Applicant: Shangdong Natergy Energy Technological Co., Ltd., Shandong (CN)

(72) Inventor: Angfeng Liu, Shandong (CN)

(21) Appl. No.: 15/999,396

(22) Filed: Aug. 16, 2018

Related U.S. Application Data
(63) Continuation of application No. PCT/CN2017/073757, filed on Feb. 16, 2017.

(30) Foreign Application Priority Data
Feb. 16, 2016 (CN) 201610086791.3

(51) Int. Cl. B64C 39/00; B64C 39/06; B64C 39/08

(52) U.S. Cl. CPC B64C 39/001; B64C 39/006; B64C 2001/0045; B64C 39/08; B64C 39/062

(57) ABSTRACT

The embodiments of the present invention provide a navigator, comprising a gyro flying device and a cover that seals and encloses the gyro flying device. The gyro flying device is connected to the cover by a retaining mechanism. The gyro flying device comprises: a gyrorotor having an axisymmetric structure and rotatable around a central axis thereof; and a driving mechanism coaxially mounted with the gyrorotor to drive the gyrorotor to rotate around the central axis thereof, thereby manipulating rise and fall of the navigator. The retaining mechanism is further disposed to adjust an inclination angle of the gyro flying device, so as to adjust a flying direction of the navigator. The navigator has the advantages of quiet, safe, frictionless, extensive uses, etc.

### CROSS-REFERENCE TO RELATED APPLICATION

The present application claims priority of Chinese application No. 201610086791.3, filed on Feb. 2, 2016 and PCT application No. PCT/CN2017/073757 filed on Feb. 16, 2017, and the content thereof is entirely incorporated herein by reference.

### TECHNICAL FIELD

The present invention relates to the field of aerospace and marine navigation technologies, and in particular to a novel navigator.

### BACKGROUND ART

The traditional aerospace vehicles, either airplanes or rockets, are driven by the hydrodynamic force or the reaction force of air or fuel gas. The traditional marine vessels (e.g., ship, submarine, etc.) are driven by the hydrodynamic force or the reaction force of water. This driving mode indispensably requires generating an air flow or a liquid flow with a strong back-blowing force, and then uses the hydrodynamic force or the reaction force to raise, move or suspend an aerospace vehicle or a marine vessel. This determines that the launch and navigation of such aerospace vehicle or marine vessel must rely on the air flow or the liquid flow, which requires an open fluid space and large-size fins, so as to generate a sufficient reaction force to realize the movement of the aerospace vehicle or the marine vessel.

The existing driving mode of the aerospace vehicle/marine vessel cannot meet the requirements such as low air/water flow disturbance, finless, noiseless, high security, while having both the aerospace and marine navigating functions.

### SUMMARY OF THE INVENTION

In order to solve the above problems, the embodiments of the present invention provide a novel navigator, which utilizes a centrifugal force generated by a high-speed rotating object relative to a star (e.g., the earth) to produce a lifting force and a free movement, and has the advantages of quiet, safe, frictionless, extensive uses, etc.

One aspect of the present invention provides a navigator that may comprise a gyro flying device and a cover that seals and encloses the gyro flying device. The gyro flying device is connected to the cover by a retaining mechanism. The gyro flying device comprises: a gyrorotor having an axisymmetric structure and rotatable around a central axis thereof; and a driving mechanism coaxially mounted with the gyrorotor to drive the gyrorotor to rotate around the central axis thereof, thereby manipulating rise and fall of the navigator, wherein the retaining mechanism is further disposed to adjust an inclination angle of the gyro flying device, so as to adjust a flying direction of the navigator.

The present teachings provide a navigator, characterized in that, it comprises a gyro flying device and a cover that seals and encloses the gyro flying device, the gyro flying device being connected to the cover by a retaining mechanism, the gyro flying device comprises: a gyrorotor having an axisymmetric structure and rotatable around a central axis thereof; and a driving mechanism coaxially mounted with the gyrorotor to drive the gyrorotor to rotate around the central axis thereof, thereby manipulating rise and fall of the navigator, wherein the retaining mechanism is further disposed to adjust an inclination angle of the gyro flying device, so as to adjust a flying direction of the navigator.

In one embodiment, the navigator may further comprise a vacuum maintaining system connected to the cover to maintain an interior of the cover in a vacuum state.

In one embodiment, the retaining mechanism may be connected to the gyro flying device through a bearing.

In one embodiment, the retaining mechanism may comprise a plurality of telescopic adjustment levers to achieve an adjustment of the inclination angle of the gyro flying device.

In one embodiment, the navigator may comprise two of the gyro flying devices arranged in upper and lower directions.

In one embodiment, the navigator may comprise three of the gyro flying devices arranged into an equilateral triangle.

In one embodiment, the driving mechanism may be an electric motor.

In one embodiment, the gyrorotor may have a cross-section structure with a thickness gradually decreased from a center to an edge.

In one embodiment, the gyrorotor may be made of a fiber material mainly composed of carbon.

According to the embodiments of the present invention, the navigator may utilize the centrifugal force of the rotating gyrorotor relative to a star to obtain the flying force, thereby achieving the advantages of quiet, safe, frictionless, extensive uses, etc.

### BRIEF DESCRIPTION OF THE DRAWINGS

The above and other advantages of the present invention will be easily understood when reading the following detailed descriptions with reference to the drawings. The drawings are shown for illustrative purposes only, rather than limitations to the present invention, wherein,

FIG. 1 is a schematic diagram illustrating a decomposition of the gravity center of an object;

FIGS. 2 to 4 are structural schematic diagrams of a navigator according to an embodiment of the present invention;

FIG. 5 is a structural schematic diagram of a navigator according to another embodiment of the present invention; and

FIG. 6 is a plan schematic diagram of a navigator according to still another embodiment of the present invention.

### REFERENCE NUMERALS

1000: navigator

1110: gyrorotor

1120: driving mechanism

1130: cover

1140: retaining mechanism

1150: bearing

1160: vacuum-pumping system

### DETAILED DESCRIPTION OF THE PREFERRED EMBODIMENTS

Next, the embodiments of the present invention will be described with reference to the drawings. Throughout the drawings, the similar reference numerals always refer to the same or similar parts/components.

To be noted, although the following description takes the “earth” as an example, the present invention is not limited thereto. The technical solutions of the present invention are also adaptive to other gravitational stars. In addition, the navigator of the present invention can navigate in either different fluid medium (e.g., air, water, etc.) or the vacuum.

Firstly, the basic principle of the present invention is introduced.

The inventor finds that when a mass point moves in a horizontal direction (including a curved movement and a linear movement on a horizontal plane), due to the continuous gravitation, actually, any moment of the horizontal movement of the mass point is also a moment constituting a circular movement around the earth made by its centering on the earth center, and a centrifugal force away from the earth center (i.e., opposite to the direction of the gravitation) is also generated; the magnitude of the moving speed of the mass point in the horizontal direction determines the magnitude of the centrifugal force of the mass point away from the earth center.

For example, when a gyro rotates around its central axis on the horizontal plane, on one hand, an arbitrary part (mass point) on the gyro is in a circular movement around the central axis of the gyro, thereby generating a centrifugal force relative to the central axis; on the other hand, at any moment, the arbitrary part (mass point) is also actually in a circular movement on an orbit around the earth in its own moving direction, thereby generating a centrifugal force away from the earth center; due to the centripetal force from the central axis of the gyro, the mass point has its moving direction changed at the next moment to enter a new circular orbit around the earth; while the change of the moving direction of the mass point does not influence the effect of the continuous generation of the centrifugal force away from the earth center by the continuously moving mass point.

When the rotation speed of the gyro is low, the centrifugal forces away from the earth center generated by various parts of the gyro will partially offset the weight of the gyro itself caused by the gravitation, so that the rotating gyro will be weightless.

As the rotation speed of the gyro increases, the centrifugal forces away from the earth center generated by various parts of the gyro increase, and when a sum (integration) of those centrifugal forces is greater than the weight of the gyro itself caused by the gravitation, the gyro as a whole will be lifted away from the ground.

The inventor also finds that when the rotating gyro is lifted and its spin plane is inclined relative to the horizontal plane, the gyro will make a lateral movement. The detailed explanation is as given follows.

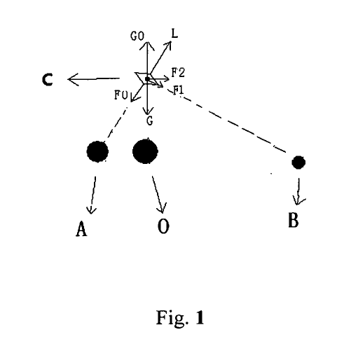

As illustrated in FIG. 1, a gravity center O of the earth can be regarded as an attraction force center of the earth, and a magnitude of an attraction force(gravity) of the earth applied to a gravity center C of the rotating gyro is G. The earth can be arbitrarily divided into two parts of different sizes, each having an independent gravity center. These two independent gravity centers can be regarded as two component gravity centers A and B of the earth, and can also be called as two component attraction force centers of the earth. When the rotating gyro is lifted and its spin plane is inclined relative to the horizontal plane, the gravity center C of the rotating gyro can be regarded as being attracted by the two component attraction force centers of the earth perpendicular to each other, wherein one of the component attraction force centers of the earth attracts the gravity center C of the rotating gyro from a direction of the rotation axis and its magnitude is denoted as F0, while the other component attraction force center attracts the gravity center C of the gyro via an outer lowest point of the inclined spin plane and its magnitude is denoted as F1. The directions of the two component attraction forces are perpendicular to each other, and a magnitude of a resultant force thereof is exactly equal to the weight G of the rotating gyro itself. When rotating at a high speed, the gyro generates a lifting force L in the direction of the rotation axis with a magnitude that can overcome the component attraction force F0 of the earth center, and rises in the axial direction that is an oblique upward direction relative to the earth plane; meanwhile, the force F1 applied on the rotating gyro by the other component attraction force center of the earth only achieves an obliquely downward pulling effect, and a resultant force of F0, F1 and L can produce a vertically upward pulling force G0 and a lateral moving force F2, wherein the magnitude of G0 can overcome the weight G to ensure the rise or fall of the gyro, and the magnitude of F2 can ensure an acceleration or a lateral resistance to be overcome of the high-speed rotating gyro for the lateral movement; the compositions of the magnitudes and the directions of the two forces lead to different moving modes (transverse horizontal, transverse upward and transverse downward) of the high-speed rotating gyro, and the movement of the rotating gyro can be flexibly controlled according to the parameters such as a vertical inclination angle, a horizontal inclination direction and a rotation speed of the rotating gyro, etc.

According to the above findings, the inventor has invented a navigator which rises based on a rotation of a gyro around its central axis. Specifically, when the average rotation linear speed of the gyro reaches a first cosmic velocity, the entire gyro will generate a centrifugal force that overcomes its own weight and then escapes from the gravitation. As the rotation speed of the gyro further increases, the centrifugal force generated will drive the entire navigator to rise.

After the navigator rised, the horizontal moving direction of the gyro can be controlled by adjusting the inclination angle of the central axis of the gyro. For example, if the navigator is hoped to fly rightwards, the central axis of the gyro may be controlled to incline to the right in a clockwise direction; on the contrary, if the navigator is hoped to fly leftwards, the central axis of the gyro may be controlled to incline to the left in a counterclockwise direction. In conclusion, regardless of the direction in which the navigator is hoped to fly, the inclination angle of the central axis of the gyro may be controlled so that an upper end thereof inclines to the desired flying direction while a lower end thereof inclines to an opposite direction.

Next, the embodiments of the navigator of the present invention will be described with reference to the drawings.

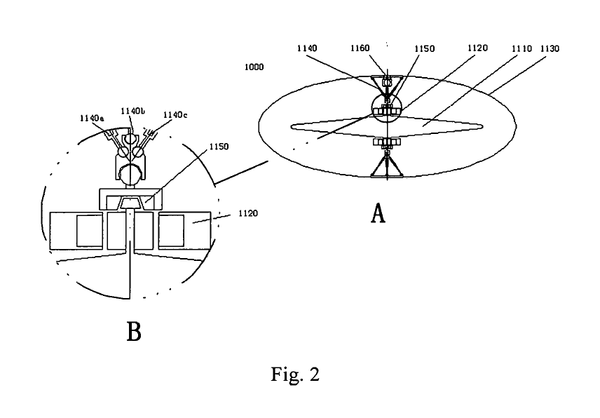

FIGS. 2 to 4 illustrate structural schematic diagrams of a navigator 1000 according to an embodiment of the present invention.

As illustrated in part A of FIG. 2, the navigator 1000 comprises a gyrorotor 1110, and a driving mechanism 1120 coaxially mounted therewith (a symmetrical structure on an upper side and a lower side is shown in FIG. 2, but it is not limited thereto, and for example, it may be mounted only on one of the upper side and the lower side). The gyrorotor 1110 has an axisymmetric structure and can be rotated around its central axis. The driving mechanism 1120 may drive the gyrorotor 1110 to rotate around its central axis, thereby generating a centrifugal force relative to a star (e.g., the earth). Thus, the gyrorotor 1110 and the driving mechanism 1120 constitute a “gyro flying device” to control the rise and fall of the navigator 1000.

The driving mechanism 1120 may be for example an electric motor.

The navigator 1000 further comprises a cover 1130 that seals and encloses the gyro flying device composed of the gyrorotor 1110 and the driving mechanism 1120.

The navigator 1000 further comprises a retaining mechanism 1140. For example, as illustrated, the retaining mechanism 1140 is longitudinally symmetrical along the central axis of the gyrorotor 1110. The gyro flying device composed of the gyrorotor 1110 and the driving mechanism 1120 is connected to the cover 1130 through the retaining mechanism 1140.

The retaining mechanism 1140 may be connected to the gyro flying device through a bearing 1150. For example, in this embodiment, the retaining mechanism 1140 is connected to the driving mechanism 1120 through the bearing 1150.

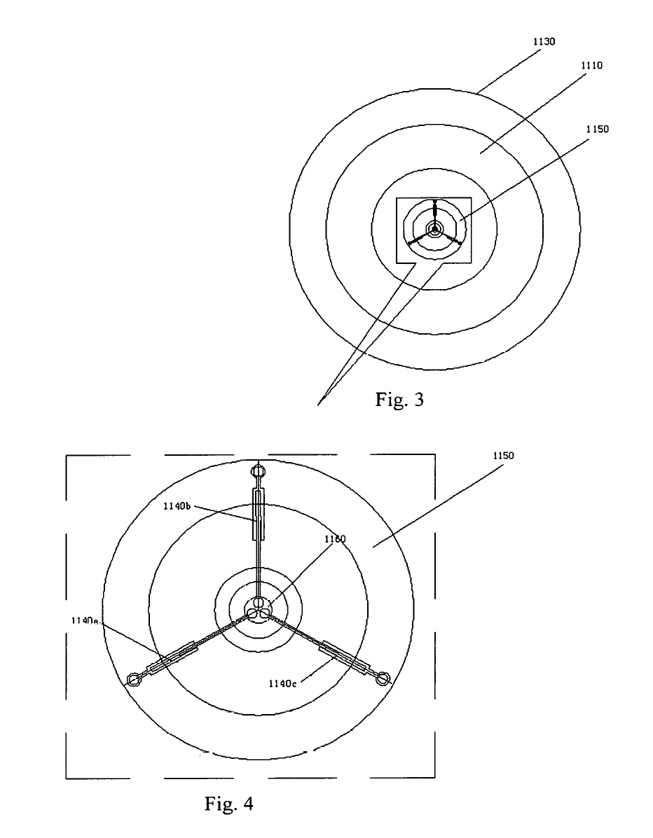

Part B of FIG. 2, FIG. 3 and FIG. 4 illustrate schematic structures of the retaining mechanism 1140 and the bearing 1150 and the schematic connection relationships therebetween, respectively, in forms of an axial side view and a plan view.

For example, as illustrated, the retaining mechanism 1140 may comprise for example, but not limited to, three telescopic adjustment levers 1140a, 1140b and 1140c. Thus, through the telescopic movement of the telescopic adjustment levers 1140a, 1140b and 1140c driven by an actuating mechanism (not shown), the retaining mechanism 1140 can adjust the inclination angle of the gyro flying device, so that the navigator 1000 flies towards an inclination direction of the gyro flying device (a direction pointed by an upper end of the central axis). As the inclination angle of the gyro flying device increases, the lateral flight force of the navigator 1000 increases, and correspondingly the lifting force decreases.

When the driving mechanism 1120 drives the gyrorotor 1110 to rotate, the gyrorotor 1110 generates a centrifugal force relative to a star (e.g., the earth). As the rotation speed of the gyrorotor 1110 increases, the centrifugal force generated relative to the star increases. When the rotation speed of the gyrorotor 1110 reaches a certain value, the centrifugal force generated by the gyrorotor 1110 relative to the star may be equal to the overall weight of the navigator 1000 (and other loads). As the rotation speed of the gyrorotor 1110 further increases, the centrifugal force generated by the gyrorotor 1110 relative to the star may be greater than the overall weight of the navigator 1000 (and other loads), thereby causing the navigator 1000 to rise. When the rotation speed of the gyrorotor 1110 decreases so that the centrifugal force generated by the gyrorotor 1110 relative to the star is less than the overall weight of the navigator 1000 (and other loads), the navigator 1000 may fall.

The navigator 1000 may further comprise a vacuum maintaining system 1160 connected to the cover 1130 for maintaining an interior of the cover 1130 in a vacuum state, so as to overcome the frictional resistance encountered by the gyrorotor 1110 during rotation.

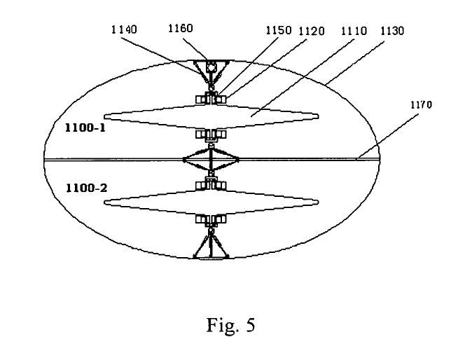

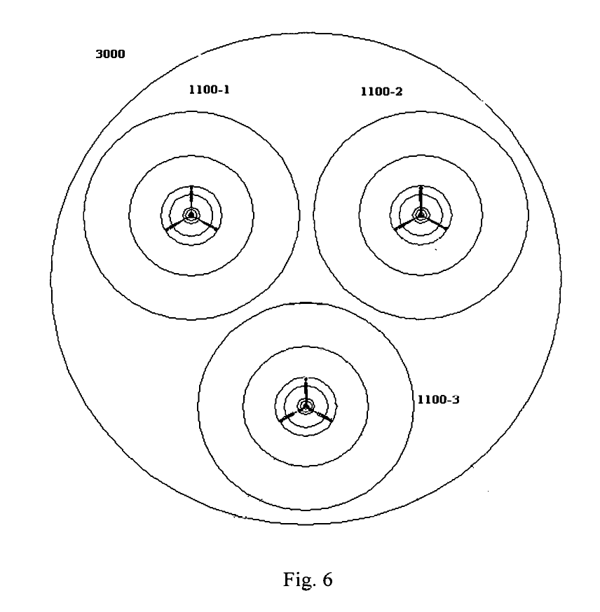

FIG. 5 illustrates a structural schematic diagram of a navigator 2000 according to another embodiment of the present invention.

Being different from the navigator 1000 as illustrated in FIGS. 2 to 4, the navigator2000 as illustrated in FIG. 5 comprises two gyro flying devices 1100-1 and 1100-2 arranged in upper and lower directions, as well as associated retaining mechanisms 1140 and bearings 1150. The retaining mechanisms 1140 of the upper gyro flying device 1100-1 and the lower gyro flying device 1100-2 are connected via a support structure 1170 that is connected to the cover 1130.

Thus, during operations, the two gyrorotors rotate in opposite directions at the same rotation speed, so that the changes of their angular momentums cancel out each other.

FIG. 6 illustrates a plan schematic diagram of a navigator 3000 according to still another embodiment of the present invention. As illustrated in FIG. 6, the cover 1130 is provided therein with three gyro flying devices 1100-1, 1100-2 and 1100-3, as well as respective associated retaining mechanisms 1140 and bearings 1150.

As illustrated in FIG. 6, the three gyro flying devices 1100-1, 1100-2 and 1100-3 are horizontally arranged to form an equilateral triangle. Since the three gyrorotors are arranged horizontally, they are not coaxial and there is no uniform axis. As long as the three gyrorotors are arranged into an equilateral triangle and rotating at the same angular momentum and direction, the three gyrorotors as a whole have no rotation angular momentum, and the changes of the internal angular momentums cancel out each other, so that the whole is stable, and no instability caused by the imbalance of angular momentum will occur to the entire navigator.

Similarly, more than three gyro flying devices may also be mounted in the cover 1130.

In addition, although not specifically described, both the navigator 2000 as illustrated in FIG. 5 and the navigator 3000 as illustrated in FIG. 6 comprise a vacuum maintaining system 1160 mounted in the cover 1130.

Next, the composition of the gyrorotor 1110 is described through an example.

For example, the gyrorotor 1110 may be made of a material with a high tensile strength and a low weight (e.g., a carbon fiber series material).

In order to disperse the internal stress of the gyrorotor 1110, the gyrorotor 1110 may be manufactured to a structure with a thickness gradually decreased from a center to an edge, so as to avoid the gyrorotor 1110 from being disintegrated under a strong centrifugal pulling force generated during high-speed rotation. The cross-section structure of the gyrorotor 1110 may have an angle for example, but not limited to, from 20 to 60 degrees at the edge. The gyrorotor of the present invention may be designed as any suitable revolving object with a suitable size according to the characteristic parameters of the materials used.

The above descriptions are just specific embodiments of the present invention, rather than limitations to the implementation scope of the present invention. Thus, the replacement of the equivalent components, or the equivalent changes and modifications made within the protection scope of the invention patent, should fall within the scope of this patent. In addition, any free combination can be made between the technical features, between the technical feature and the technical solution, and between the technical solutions.

1. A navigator comprising:
a gyro flying device and a cover that seals and encloses the gyro flying device, the gyro flying device being connected to the cover by a retaining mechanism, the gyro flying device comprises:
a gyrorotor having an axisymmetric structure and rotatable around a central axis thereof; and
a driving mechanism coaxially mounted with the gyrorotor to drive the gyrorotor to rotate around the central axis thereof, thereby manipulating rise and fall of the navigator,
wherein the retaining mechanism is further disposed to adjust an inclination angle of the gyro flying device, so as to adjust a flying direction of the navigator.

2. The navigator according to claim 1, wherein the navigator further comprises a vacuum maintaining system connected to the cover to maintain an interior of the cover in a vacuum state.

3. The navigator according to claim 2, wherein the retaining mechanism is connected to the gyro flying device through a bearing.

4. The navigator according to claim 3, wherein the retaining mechanism comprises a plurality of telescopic adjustment levers to achieve an adjustment of the inclination angle of the gyro flying device.

5. The navigator according to claim 4, wherein the navigator comprises two of the gyro flying devices arranged in upper and lower directions

6. The navigator according to claim 4, wherein the navigator comprises three of the gyro flying devices arranged into an equilateral triangle.

7. The navigator according to claim 1, wherein the driving mechanism is an electric motor.

8. The navigator according to claim 1, wherein the gyrorotor has a cross-section structure with a thickness gradually decreased from a center to an edge.

9. The navigator according to claim 8, wherein the gyrorotor is made of a fiber material mainly composed of carbon.

10. The navigator according to claim 6, wherein the driving mechanism is an electric motor.

11. The navigator according to claim 10, wherein the gyrorotor has a cross-section structure with a thickness gradually decreased from a center to an edge.

12. The navigator according to claim 11, wherein the gyrorotor is made of a fiber material mainly composed of carbon.
